(19) United States
(12) Patent Application Publication
(10) Pub. No.: US 2023/0409868 A1
(43) Pub. Date: Dec. 21, 2023

(54) Neural Network Activation Scaled Clipping Layer

(71) Applicant: Advanced Micro Devices, Inc., Santa Clara, CA (US)

(72) Inventors: Hai Xiao, Fremont, CA (US); Adam H Li, Solana Beach, CA (US); Harris Eleftherios Gasparakis, Nashua, NH (US)

(73) Assignee: Advanced Micro Devices, Inc., Santa Clara, CA (US)

(21) Appl. No.: 17/844,204

(22) Filed: Jun. 20, 2022

(51) Int. Cl. G06N 3/04; G06N 3/08

(52) U.S. Cl. CPC G06N 3/04; G06N 3/08

(57) ABSTRACT

Activation scaled clipping layers for neural networks are described. An activation scaled clipping layer processes an output of a neuron in a neural network using a scaling parameter and a clipping parameter. The scaling parameter defines how numerical values are amplified relative to zero. The clipping parameter specifies a numerical threshold that causes the neuron output to be expressed as a value defined by the numerical threshold if the neuron output satisfies the numerical threshold. In some implementations, the scaling parameter is linear and treats numbers within a numerical range as being equivalent, such that any number in the range is scaled by a defined magnitude, regardless of value. Alternatively, the scaling parameter is nonlinear, which causes the activation scaled clipping layer to amplify numbers within a range by different magnitudes. Each scaling and clipping parameter is learnable during training of a machine learning model implementing the neural network.

### BACKGROUND

As machine learning models continue to improve and become increasingly complex, the time required to train a machine learning model has increased significantly. To address this challenge, some conventional model training approaches represent training data via reduced precision. For instance, some conventional approaches restrict a number of bits used by a machine learning model to represent data. Although using reduced data precision significantly accelerates model training time, doing so inhibits model performance.

### BRIEF DESCRIPTION OF THE DRAWINGS

The detailed description is described with reference to the accompanying figures.

FIG. 1 illustrates an example of a neural network having at least one logic block that is associated with an activation scaled clipping layer.

FIG. 2 illustrates an example of functionality performed by a linear activation scaled clipping layer.

FIG. 3 illustrates an example of functionality performed by a nonlinear activation scaled clipping layer.

FIG. 4 is a block diagram of an example model training system configured to generate a trained machine learning model configured as a neural network having at least one logic block that is associated with an activation scaled clipping layer.

FIG. 5 is a flow diagram depicting a procedure in an example implementation of generating a trained machine learning model configured as a neural network having at least one node that is associated with an activation scaled clipping layer.

### DETAILED DESCRIPTION

### Overview

As neural networks become more robust and advanced, network complexity requires increased training time and increased computational resources for storing, processing, and transmitting the data used to train machine learning models implementing these neural networks. In an effort to maximize performance while minimizing computational resource consumption and minimizing training time, conventional model training approaches implement reduced precision data representations. For instance, some conventional approaches utilize full precision float data that represents numbers using 32 bits while other conventional approaches utilize half precision float data that represents numbers using 16 bits. Model training approaches that implement quarter precision float data represents numbers using eight bits, and further reduced precision float data represents numbers using fewer than eight bits.

While reduced precision data consequently reduces computational resource consumption and model training time, reduced precision data introduces problems in training machine learning models. For instance, using reduced precision data results in a machine learning model that produces lower precision outputs and thus less accurate results. Lower precision outputs are a consequence of having fewer bits available to represent a number, which results in a narrower range of numbers that can be expressed relative to a range of numbers expressible by additional bits. For instance, the minimum absolute value that can be represented by reduced precision float data is further from zero relative to a minimum absolute value that can be represented using additional bits. Similarly, the maximum absolute value that can be represented by reduced precision float data is closer to zero relative to a maximum absolute value that can be represented using additional bits. Although implementations are described with respect to representing numbers using float data, or floating-point numbers, the techniques described herein apply to any suitable numerical representation formatting. For instance, the techniques described herein are applicable to data representation formats including integers of various precisions, complex numbers, block-based numbers (e.g., blocks that share exponent, bias, and the like), log-based numbers, and so forth.

As a machine learning model converges during training, small numbers have a significant impact on outputs generated by the model. Generally, during initial training iterations, large changes are made to model parameters. As training iterations progress, the parameter modifications become more granular and refined. Consequently, numbers closer to zero are of significant importance in machine learning model training. Because reduced precision data limits a numerical range, numbers close to zero that are significant in training often fall outside the numerical range, which leads to suboptimal model parameters. As further problems, machine learning models trained on reduced precision data suffer from lower dynamic range values, suffer from vanishing gradient issues, and so forth.

To solve these problems, activation scaled clipping layers are described. As described herein, an activation scaled clipping layer is associated with a scaling parameter and a clipping parameter. The scaling parameter influences a degree by which numerical values are amplified, relative to zero, thus inflating smaller numbers that would otherwise be impossible to express using reduced precision float data (e.g., data representing numbers using eight or fewer bits). The clipping parameter associated with an activation scaled clipping later represents an acknowledgement that because larger numerical values are less significant as training progresses towards convergence, the specific value of the larger number can be disregarded if it satisfies a clipping threshold. Thus, the clipping parameter causes the machine learning model to regard numbers that satisfy the clipping threshold as having the same significance.

Each activation scaled clipping layer is associated with a logic block (e.g., a node) in a neural network architecture. In this manner, an output of the node is first processed by the activation scaled layer according to it scaling and clipping parameters before the output is used to activate another node of the neural network. Using the techniques described herein, the scaling parameter and the clipping parameter associated with each activation scaled clipping layer are individually learnable during training of the machine learning model that implements the neural network architecture. To do so, terms for each of the scaling and clipping parameters are defined in a loss function computed during training of the machine learning model.

In implementations, each activation scaled clipping layer is configured as either a linear activation scaled clipping layer or a nonlinear activation scaled clipping layer. For linear activation scaled clipping layers, the scaling parameter causes the activation scaled clipping layer to treat numbers within a numerical range as being equivalent, such that any number in the range is scaled by a defined magnitude, regardless of value. In some implementations, prior to scaling, the activation scaled clipping layer performs statistical centering of numerical values output by the node. For nonlinear activation scaled clipping layers, the scaling parameter causes the activation scaled clipping layer to treat different numbers within a range of numerical values differently. In this manner, numbers closer to zero are scaled more aggressively or less aggressively relative to numbers that are closer to a clipping threshold, as defined by the clipping parameter for the activation scaled clipping layer.

The techniques described herein thus advantageously enable a machine learning model implementing reduced precision data to generate outputs of equal effective precision relative to machine learning models implementing increased precision data, while significantly reducing a computational cost and training time required to generate the machine learning model.

In some aspects, the techniques described herein relate to a method including initializing a machine learning model by assigning a scaling parameter and a clipping parameter to one or more activation layers of the machine learning model, generating a trained machine learning model configured to produce an output that classifies one or more features of input data by: causing the machine learning model to generate predicted outputs based on input training data, generating a loss function based on the predicted outputs, and modifying at least one of the scaling parameter or the clipping parameter using the loss function, and outputting the trained machine learning model.

In some aspects, the techniques described herein relate to a method, wherein the machine learning model includes a neural network including a plurality of neurons, each of the plurality of neurons configured to produce an output using a numerical representation of eight or fewer bits.

In some aspects, the techniques described herein relate to a method, wherein the machine learning model includes a neural network including a plurality of neurons, each of the plurality of neurons being associated with one of the one or more activation layers and configured to produce an output that is processed by the one of the one or more activation layers to activate another one of the plurality of neurons.

In some aspects, the techniques described herein relate to a method, wherein the scaling parameter defines a degree by which a numerical value within a range of numerical values is to be amplified relative to zero.

In some aspects, the techniques described herein relate to a method, wherein the scaling parameter causes linear amplification of the range of numerical values relative to zero.

In some aspects, the techniques described herein relate to a method, wherein the scaling parameter causes nonlinear amplification of the range of numerical values relative to zero.

In some aspects, the techniques described herein relate to a method, wherein the clipping parameter defines a threshold numerical value and causes numerical values output by the one or more activation layers that satisfy the threshold numerical value to be expressed as the threshold numerical value.

In some aspects, the techniques described herein relate to a method, wherein training the machine learning model is performed over a plurality of training iterations and includes performing the causing the machine learning model to generate the predicted outputs based on the input training data, the generating the loss function based on the predicted outputs, and the modifying the at least one of the scaling parameter or the clipping parameter using the loss function during each of the plurality of training iterations.

In some aspects, the techniques described herein relate to a method, wherein outputting the machine learning model is performed responsive to determining that the predicted outputs generated during training satisfy a threshold difference from ground truth information for the training data.

In some aspects, the techniques described herein relate to a method, wherein generating the loss function includes comparing the predicted outputs to ground truth information for the training data.

In some aspects, the techniques described herein relate to a method, the method further including producing the output that classifies the one or more features of the input data by providing the input data as input to the trained machine learning model.

In some aspects, the techniques described herein relate to a method including obtaining a machine learning model that includes a neural network including a plurality of neurons, at least one of the plurality of neurons being associated with an activation layer that processes a numerical value output by the one of the plurality ofneurons using a scaling parameter and a clipping parameter; and causing the neural network to produce an output that classifies one or more features of input data by inputting the input data to the machine learning model, the output that classifies the one or more features of input data being generated based on a result of the activation layer processing the numerical value output by the one of the plurality of neurons using the scaling parameter and the clipping parameter.

In some aspects, the techniques described herein relate to a method, wherein the scaling parameter defines a degree by which the numerical value is to be amplified relative to zero responsive to determining that the numerical value is within a range of numerical values.

In some aspects, the techniques described herein relate to a method, wherein the scaling parameter causes linear amplification of the numerical value responsive to determining that the numerical value is within the range of numerical values.

In some aspects, the techniques described herein relate to a method, wherein the scaling parameter causes nonlinear amplification of the numerical value responsive to determining that the numerical value is within the range of numerical values.

In some aspects, the techniques described herein relate to a method, wherein the clipping parameter defines a threshold numerical value and causes the numerical value output by the one of the plurality of neurons to be expressed as the threshold numerical value responsive to determining that the numerical value output by the one of the plurality of neurons satisfies the threshold numerical value.

In some aspects, the techniques described herein relate to a method, wherein the numerical value output by the one of the plurality of neurons is expressed using eight or fewer bits.

In some aspects, the techniques described herein relate to a system including an initialization module to initialize a machine learning model by assigning a scaling parameter and a clipping parameter to one or more activation layers of the machine learning model, a training module to generate a trained machine learning model by causing the machine learning model to generate predicted outputs based on input training data, generating a loss function based on the predicted outputs, and modifying at least one of the scaling parameter or the clipping parameter using the loss function, and a prediction model to generate an output by processing input data using the trained machine learning model.

In some aspects, the techniques described herein relate to a system, wherein the machine learning model includes a neural network including a plurality of neurons, each of the plurality of neurons configured to produce an output using a numerical representation of eight or fewer bits.

In some aspects, the techniques described herein relate to a system, wherein the scaling parameter defines a degree by which a numerical value within a range of numerical values is to be amplified relative to zero and the clipping parameter defines a threshold numerical value and causes numerical values that satisfy the threshold numerical value to be expressed as the threshold numerical value.

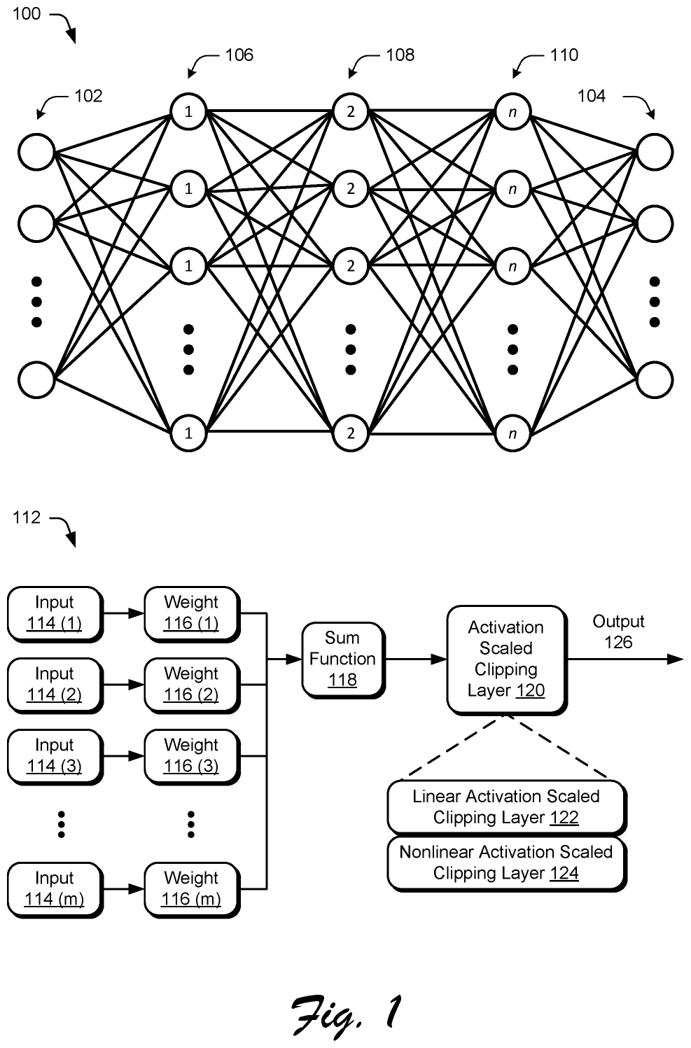

FIG. 1 illustrates an example 100 of a neural network having at least one node that is associated with an activation scaled clipping layer. In the illustrated example 100, the neural network is representative of a portion or an entirety of a machine learning model configured to produce an output that classifies one or more features of input data in accordance with the techniques described herein. In this manner, the neural network depicted in the example 100 is configured to map inputs to outputs, where input data is abstracted by nodes into higher-level features that are useable to produce an output that classifies the input data.

For instance, consider an example implementation where the machine learning model includes a deep neural network configured to perform image classification. In this example implementation, when provided an input image that depicts a car in the form of an array of digital pixels, hidden layers in the neural network first abstract pixel values to predict edges depicted in the image, arrange the predicted edges to identify objects, assign a label to each identified object (e.g., tire, door, headlight, etc.), and predict a depicted object based on the assigned labels.

By abstracting input data into higher-level features that classify one or more features of input data, machine learning models implementing neural networks are capable of being tailored to a diverse range of objectives. As such, the techniques described herein extend to machine learning models configured for a variety of objectives and are not so limited to the described example classification objectives. Rather, the activation scaled clipping layers described herein are configured for implementation in any type of neural network, regardless of objective for which the machine learning model implementing the neural network is configured. For instance, in addition to image classification objectives, the techniques described herein are configured for implementation using machine learning models configured for speech recognition, image generation, graph classification, text processing, anomaly detection, recommendation systems, combinations thereof, and so forth.

The machine learning model that includes a neural network represented by example 100 is configured for implementation by a variety of computing device types. For instance, by way of example and not limitation, the machine learning model is configured to be implemented by a processor (e.g., graphics processing, central processing units, and so forth), disk array controllers, hard disk drives, memory cards, solid-state devices, communication hardware components, switches, bridges, network interface controllers, and so forth. In some implementations, the machine learning model that includes a neural network represented by example 100 is implemented in software. For instance, the machine learning model is part of an operating system of a computing device or software of a computing device component.

Alternatively or additionally, the machine learning model is implemented in hardware. For instance, the machine learning model is implemented in an integrated circuit of a computing device component. As such, the machine learning model that implements a neural network represented by example 100 is configured for implementation in a smartphone or other wireless phone, a tablet or phablet computer, a notebook computer (e.g., netbook or ultrabook), a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television), an Internet of Things (IoT) device, an automotive computer, and so forth.

In the illustrated example 100, the neural network architecture includes an input layer 102, an output layer 104, and a plurality of hidden layers disposed between the input layer 102 and the output layer 104, depicted as hidden layer 106, hidden layer 108, and hidden layer 110. Each layer includes one or more neurons, which are individually represented by circles in the neural network architecture depicted by example 100. For instance, the input layer 102 is illustrated as including three input neurons. Although illustrated as including three neurons, the input layer 102 is representative of an input layer including any number of neurons, as represented by the ellipses separating the bottom neuron from other neurons of the input layer 102. In a similar manner, the output layer 104 is configured to include any number of output neurons and is not so limited to the three neurons depicted in the architecture of example 100.

The neural network architecture depicted in example 100 is further representative of a neural network that includes any number of hidden layers and is not limited to the depicted configuration of three hidden layers. For instance, the neural network is configured to include n different hidden layers, where n represents any integer. Each hidden layer includes a plurality of neurons. For instance, hidden layer 106 includes neurons labeled “1,” hidden layer 108 includes neurons labeled “2,” and hidden layer 110 includes neurons labeled “n.” As represented by the ellipses depicted in each of the hidden layers, each hidden layer is configured to include any number of neurons.

In the neural network architecture depicted by example 100, the various layers are fully connected, such that each neuron in one layer is connected to each neuron in the adjacent layer as represented by individual lines connecting one neuron to another. Although illustrated in the context of a fully connected neural network, the activation scaled clipping layers described herein are not so limited to implementation by fully connected neural networks. Generally, each neuron in the neural network of example 100 is representative of a function configured to generate an output value from one or more input values.

In some implementations, neurons included in the input layer 102 and the output layer 104 are not representative of a function and are instead representative of inputs to, and outputs from the machine learning model implementing the neural network. As described in further detail below, one or more of the neurons in the illustrated example 100 is associated with an activation scaled clipping layer using the techniques described herein.

The illustrated example 112 depicts functionality of a neuron associated with an activation scaled clipping layer. The function implemented by the neuron as represented in the example 112 is configured to calculate a weighted sum of inputs to the neuron. For instance, example 112 depicts an implementation where the neuron receives an input 114 from each of m different neurons, such that input 114(1) is received from a first neuron, input 114(2) is received from a second neuron, input 114(3) is received from a third neuron, and input 114(m) is received from a fourth neuron. In the example 112, m represents any integer, as indicated by the ellipses separating input 114(3) and input 114(m). Upon receiving each input 114, the neuron represented by example 112 multiplies the input 114 using a weight 116.

In some implementations, the weight 116 by which an input 114 is multiplied depends on a source from which the input 114 was received. For instance, the neuron represented by example 112 is configured to multiply input 114(1) by weight 116(1), multiply input 114(2) by weight 116(2), multiply input 114(3) by weight 116(3), and multiply input 114(m) by weight 116(m). In implementations, each weight 116 is optimized during training, as described in further detail below. In this manner, each weight 116 is representative of any suitable value that is initialized and learned during training of a machine learning model implementing the neural network of example 100.

After multiplying each input 114 by its corresponding weight 116, the neuron represented by example 112 aggregates the weighted inputs using sum function 118. The aggregate of weighted inputs as processed by the sum function 118 is then provided as input to an activation scaled clipping layer 120. The activation scaled clipping layer 120 is representative of an activation function, or transformation, applied to the aggregated weighted inputs.

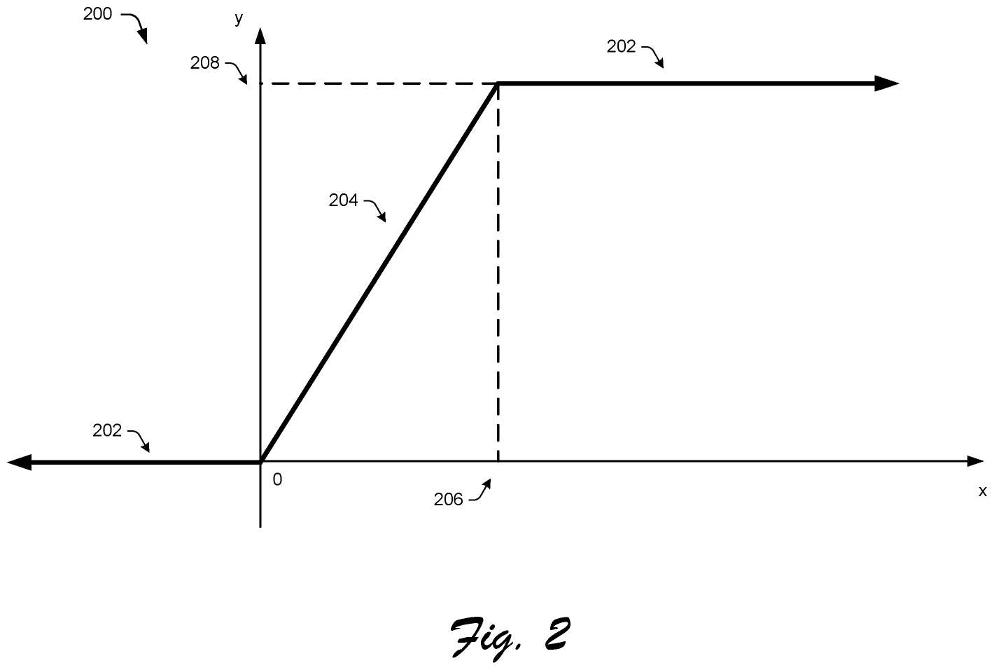

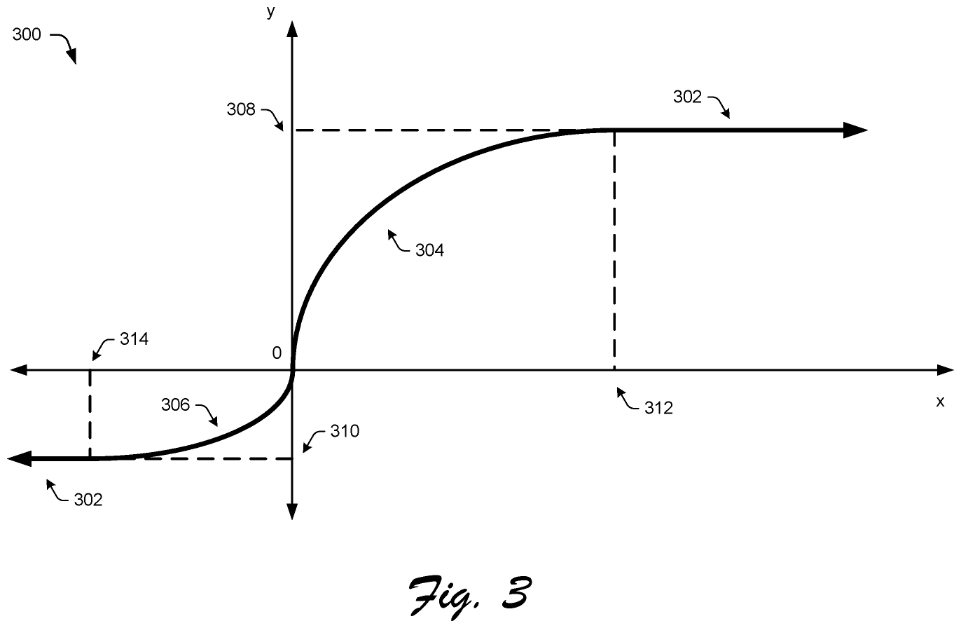

As described herein, the activation scaled clipping layer 120 is configured as either a linear activation scaled clipping layer 122 or a nonlinear activation scaled clipping layer 124. Functionality of the activation scaled clipping layer 120, when configured as a linear activation scaled clipping layer 122, is described in further detail below with respect to FIG. 2. Functionality of the activation scaled clipping layer 120, when configured as a nonlinear activation scaled clipping layer 124, is described in further detail below with respect to FIG. 3.

The activation scaled clipping layer 120 processes the aggregate weighted inputs as produced by the sum function 118 to generate an output 126. Output 126 exemplifies an output of the neuron represented by example 112, subsequent to processing by the activation scaled clipping layer 120. In some implementations, the output 126 is used to classify one or more features of input data (e.g., data provided as input to the machine learning model implementing the neural network represented by example 100). In some implementations, the output 126 is configured as a numerical representation in the form of a plurality of bits.

In implementations where the machine learning model represents data using reduced precision float data, the output 126 is configured as a numerical representation that includes no more than eight bits (e.g., eight bits, four bits, etc.). In some implementations, the output 126, as processed by the activation scaled clipping layer 120, is used to activate another one of the plurality of neurons included in the neural network represented by example 100. For a detailed description of how the activation scaled clipping layer 120 processes an output of a neuron (e.g., an output of sum function 118), consider FIGS. 2 and 3.

FIG. 2 illustrates an example 200 of functionality performed the activation scaled clipping layer 120 when configured as linear activation scaled clipping layer 122. The illustrated example 200 depicts a graphical representation of a line 202 representing a numerical value produced by the linear activation scaled clipping layer 122, such as a numerical value encoded as output 126. The numerical value generated by the linear activation scaled clipping layer 122, represented as output 126, is computed from the output of the sum function 118 and constrained by a scaling parameter and a clipping parameter. The scaling parameter for the linear activation scaled clipping layer 122 specifies a degree by which a numerical value output by the sum function 118 is to be amplified relative to zero. In some implementations, the scaling parameter constrains scaling by a range of numerical values, such that the numerical value output by the sum function 118 is amplified when it falls within the constrained range of numerical values.

For instance, in the illustrated example 200, amplification defined by the scaling parameter of the linear activation scaled clipping layer 122 is represented by the slope

$$204 ( \frac{\partial y}{\partial x} ( > 1 ) ) ,$$

indicating scaling of values along the x-axis of the graph between zero and point 206. Consequently, an output of the sum function 118 is amplified by the linear activation scaled clipping layer 122 to generate the output 126 by processing the numerical value output by the sum function 118 according to the scaling parameter.

The clipping parameter for the linear activation scaled clipping layer 122 defines a threshold numerical value. The clipping parameter causes the linear activation scaled clipping layer 122 to express the output 126 as the threshold numerical value if the numerical value output by the sum function 118, after amplification according to the scaling parameter, satisfies the threshold numerical value. For instance, in the illustrated example 200, the threshold numerical value is defined along the y-axis of the graph by point 208. Consequently, when an output of the sum function 118 is a numerical value that, after processing by the linear activation scaled clipping layer 122 according to its scaling parameter, satisfies the threshold numerical value (e.g., is greater than or greater than or equal to the numerical value specified by point 208), the linear activation scaled clipping layer 122 generates the output 126 to specify the numerical value defined by point 208.

Functionality of the linear activation scaled clipping layer 122 is thus represented by Equation 1, with scaling parameters and clipping parameter C:

$$y = 0.5 ( \vert s \cdot x \vert - \vert s \cdot x - C \vert + C ) = \{ \begin{matrix}0 , & x ∈ ( - ∞ , 0 ) \\ s \cdot x , & x ∈ [ 0 , \frac{C}{S} ) \\ C , & x ∈ [ \frac{C}{s} , + ∞ )\end{matrix} \qquad ( Eq . 1 )$$

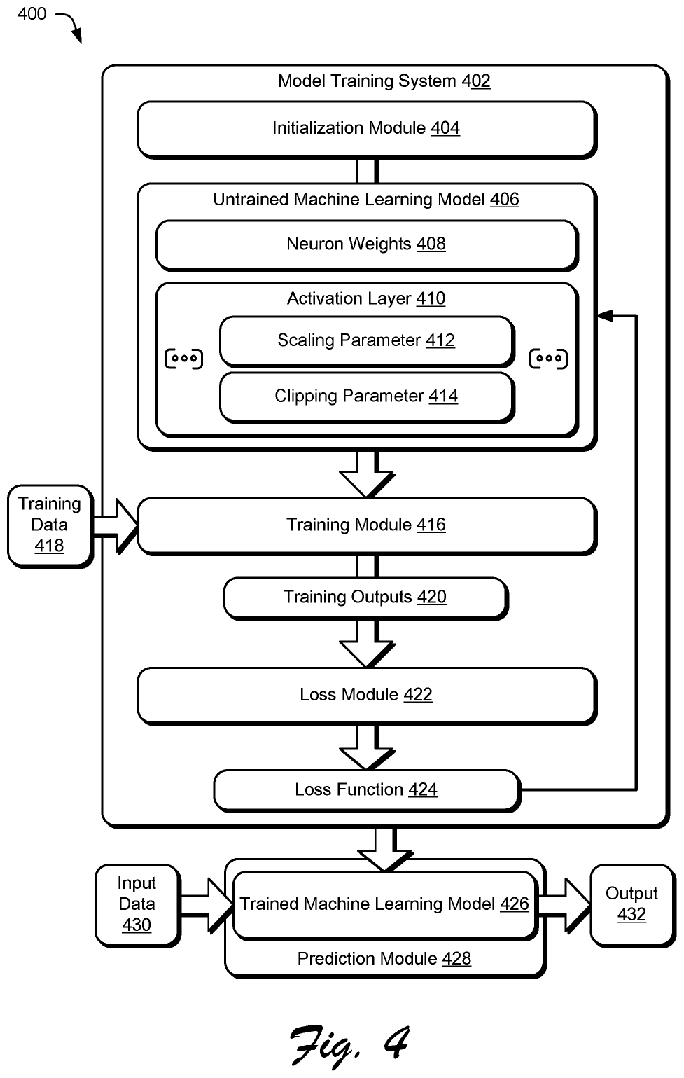

In Equation 1, y represents the function implemented by the linear activation scaled clipping layer 122 and x represents the numerical value output by the sum function 118. In Equation 1, C represents the numerical value indicated by point 208, and s represents the scaling parameter that scales the output of the sum function 118 by a magnitude represented by slope 204, such that C s represents the threshold numerical value represented by point 206. As described in further detail below with respect to FIG. 4, values for s and C in Equation 1 are optimized during training of the machine learning model implementing the neural network represented by example 100.

Although described and illustrated as being implemented following processing by a neuron of a machine learning model implementing a neural network, in some implementations functionality of the linear activation scaled clipping layer 122 is implemented upon input to the machine learning model and prior to processing by one or more neurons of the neural network. For instance, in an example implementation the linear activation scaled clipping layer 122 is implemented at the input layer 102, such that inputs provided to other layers of the machine learning model (e.g., hidden layer 106) are first processed according to the scaling and clipping parameters of the linear activation scaled clipping layer 122. In this manner, functionality of the linear activation scaled clipping layer 122 is useable to perform linear input normalization prior to processing by the machine learning model.

FIG. 3 illustrates an example 300 of functionality performed by the activation scaled clipping layer 120 when configured as nonlinear activation scaled clipping layer 124. The illustrated example 300 depicts a graphical representation of a line 302 that represents a numerical value produced by the nonlinear activation scaled clipping layer 124 (e.g., a numerical value encoded as output 126). The numerical value generated by the nonlinear activation scaled clipping layer 124, represented as output 126, is computed based on the output of the sum function 118 and constrained by a scaling parameter and a clipping parameter.

The scaling parameter for the nonlinear activation scaled clipping layer 124 defines a range of numerical values and specifies a function (e.g., a trigonometric function) for processing the output of the sum function 118 when the output of the sum function 118 falls within the range of numerical values. In some implementations, the scaling parameter for the nonlinear activation scaled clipping layer 124 defines different ranges of numerical values. For instance, the scaling parameter for the nonlinear activation scaled clipping layer 124 defines a first range of positive numerical values and a second range of negative numerical values. Scaling of outputs received from the sum function 118 is performed if the outputs fall within one of the ranges of numerical values specified by the scaling parameter.

Although FIG. 3 illustrates an example scenario where the scaling parameter defines first and second ranges of numerical values, in alternative implementations only a single range of numerical values is specified by the scaling parameter. For instance, in an implementation where the scaling parameter does not define how to scale numbers output by the sum function 118 that are less than zero, the nonlinear activation scaled clipping layer 124 defaults to generating corresponding outputs 126 that equal zero. In this example implementation, assigning numbers output by the sum function 118 of zero or less as values of zero when represented in outputs 126 would appear graphically similar to the portion of line 202 to the left of the y-axis, as depicted in FIG. 2.

In the illustrated example 300, a first range of numerical values specified by the scaling parameter for the nonlinear activation scaled clipping layer 124 is defined along the x-axis of the graph for positive numbers. When an output of the sum function 118 is a numerical value greater than zero, the nonlinear activation scaled clipping layer 124 generates the output 126 using a scaling function defined by the scaling parameter for the first range of numerical values. The scaling function defined for the first range of numerical values is represented by curve 304, which indicates how a value output by the sum function 118 relative to the x-axis is processed by the scaling function to achieve a value relative to the y-axis, where the value relative to the y-axis represents the output 126.

In the illustrated example 300, the second range of numerical values specified by the scaling parameter for the nonlinear activation scaled clipping layer 124 is defined as negative numbers along the x-axis of the graph. When an output of the sum function 118 is a numerical value less than zero, the nonlinear activation scaled clipping layer 124 generates the output 126 using a scaling function defined by the scaling parameter for the second range of numerical values. The scaling function defined for the second range of numerical values is represented by curve 306, which indicates how a value output by the sum function relative to the x-axis is processed by the scaling function to achieve a value relative to the y-axis, where the value relative to the y-axis represents the output 126.

In a similar manner, in some implementations the clipping parameter for the nonlinear activation scaled clipping layer 124 defines different threshold numerical values for clipping an output of the sum function 118 to generate output 126. For instance, the clipping parameter for the nonlinear activation scaled clipping layer 124 defines a first threshold value for clipping positive numerical values output by the sum function 118 and a second threshold value for clipping negative numerical values output by the sum function 118.

The first threshold value causes the nonlinear activation scaled clipping layer 124 to express the output 126 as the first threshold value if the numerical value output by the sum function 118, after processing according to the scaling parameter, satisfies the first threshold numerical value. For instance, in the illustrated example 300, the first threshold numerical value is defined along the y-axis as point 308. Consequently, when an output of the sum function 118, processed according to the scaling parameter, is a numerical value that satisfies the first threshold numerical value (e.g., is greater than or equal to the numerical value specified by point 308), the nonlinear activation scaled clipping layer 124 generates the output 126 as specifying the numerical value indicated by point 308.

The second threshold value causes the nonlinear activation scaled clipping layer 124 to express the output 126 as the second threshold value if the numerical value output by the sum function 118, as processed according to the scaling parameter, satisfies the second threshold numerical value. For instance, in the illustrated example 300, the second threshold numerical value is defined along the y-axis as point 310. Consequently, when an output of the sum function 118, after processing according to the scaling parameter, is a numerical value that satisfies the second threshold numerical value (e.g., is less than or equal to the numerical value specified by point 310), the nonlinear activation scaled clipping layer 124 generates the output as specifying the numerical value indicated by point 310.

Thus, when the output of the sum function 118 falls within a range of values specified by the scaling parameter (e.g., positive numbers or negative numbers), the scaling parameter causes the nonlinear activation scaled clipping layer to amplify the output of the sum function 118 by a designated function for the range of values. Further, when the output of the sum function 118 is processed according to the scaling parameter and results in a value that satisfies a threshold numerical value specified by the clipping parameter (e.g., the threshold numerical value specified by point 308 or by point 310), the output 126 is clipped. For instance, the clipping parameter causes the nonlinear activation scaled clipping layer 124 to generate an output 126 that specifies the value associated with the corresponding threshold numerical value (e.g., the numerical value indicated by point 308 or the numerical value indicated by point 310). The scaling function implemented by the nonlinear activation scaled clipping layer 124 is representative of any nonlinear function. As an example, the scaling function for a range of numerical values is a trigonometric sine function. If the curve 304 and the curve 306 of the illustrated example 300 are each representative of sine functions, functionality of the nonlinear activation scaled clipping layer is represented by Equation 2:

$$y = \{ \begin{matrix}{s}_{2} , & x ∈ ( - ∞ , {C}_{2} ) \\ {s}_{2} * sin ( \frac{x}{{C}_{2}} \times \frac{π}{2} ) , & x ∈ [ {C}_{2} , 0 ) \\ {s}_{1} * sin ( \frac{x}{{C}_{1}} \times \frac{π}{2} ) , & x ∈ [ 0 , {C}_{1} ) \\ {s}_{1} , & x ∈ [ {C}_{1} , + ∞ )\end{matrix} \qquad ( Eq . 2 )$$

As another example, in an implementation where the nonlinear activation scaled clipping layer 124 expresses any negative value output by the sum function 118 as zero, functionality of the nonlinear activation scaled clipping layer 124 is represented by Equation 3:

$$y = \{ \begin{matrix}0 , & x ∈ ( - ∞ , 0 ) \\ {s}_{1} * sin ( \frac{x}{{C}_{1}} \times \frac{π}{2} ) , & x ∈ [ 0 , {C}_{1} ) \\ {s}_{1} , & x ∈ [ {C}_{1} , + ∞ )\end{matrix} \qquad ( Eq . 3 )$$

In Equations 2 and 3, y represents the function implemented by the nonlinear activation scaled clipping layer 124 and x represents the numerical value output by the sum function 118. In Equation 2, C₂ represents the numerical value indicated by point 314. In Equations 2 and 3, C₁ represents the numerical value indicated by point 312. In Equations 2 and 3, s₁ represents the numerical value indicated by point 308 and S₂ represents the numerical value indicated by point 310. Values for each of the variables s₁, s₂, C₁ and C₂ are optimized during training of the machine learning model implementing the nonlinear activation scaled clipping layer 124, such as a model implementing the neural network represented by example 100.

Although described and illustrated as being implemented following processing by a neuron of a machine learning model implementing a neural network, in some implementations functionality of the nonlinear activation scaled clipping layer 124 is implemented upon input to the machine learning model and prior to processing by one or more neurons of the neural network. For instance, in an example implementation the nonlinear activation scaled clipping layer 124 is implemented at the input layer 102, such that inputs provided to other layers of the machine learning model (e.g., hidden layer 106) are first processed according to the scaling and clipping parameters of the nonlinear activation scaled clipping layer 124. In this manner, functionality of the nonlinear activation scaled clipping layer 124 is useable to perform nonlinear input normalization (e.g., normalization in favor of subsequently using fewer bits for numerical data representation) prior to processing by the machine learning model.

For a detailed description of generating a trained machine learning model that includes at least one activation scaled clipping layer 120, consider FIG. 4.

FIG. 4 illustrates an example 400 in which a model training system 402 generates a trained machine learning model that includes at least one activation scaled clipping layer 120, such as a machine learning model that includes a neural network represented by the example 100. The model training system 402, together with its modules described below, is implemented at least partially in hardware of a device, such as a general-purpose computer, a processor, or a processor core. In the illustrated example 400, the model training system 402 includes an initialization module 404. The initialization module 404 represents functionality of the model training system 402 to obtain an untrained machine learning model 406 and initialize various parameters of the untrained machine learning model 406. The untrained machine learning model 406 is representative of any suitable machine learning model that includes a neural network having an objective that causes the model to produce an output that classifies one or more features of input data. The untrained machine learning model 406 represents an untrained or undertrained model having parameters that differ from final model parameters learned during training.

Parameters of the untrained machine learning model 406 initialized by the initialization module 404 include neuron weights 408. The neuron weights 408 are representative of weights and biases of the untrained machine learning model 406 that are learnable during training, such as the weights 116 for the neuron represented by the example 112. The initialization module 404 is further configured to initialize parameters for at least one activation layer 410 included in the untrained machine learning model 406, such as a scaling parameter 412 and a clipping parameter 414 for the activation layer 410. In implementations, the at least one activation layer 410 is representative of the activation scaled clipping layer 120. Thus, the at least one activation layer 410 is representative of a linear activation scaled clipping layer 122 or a nonlinear activation scaled clipping layer 124. In some implementations, the untrained machine learning model 406 includes a plurality of linear activation scaled clipping layers 122, a plurality of nonlinear activation scaled clipping layers 124, or combinations thereof.

The initialization module 404 is configured to initialize parameters of an activation layer 410 on an individual basis, such that the scaling parameter 412 and the clipping parameter 414 for one at least one activation layer 410 are different than the scaling parameter 412 and the clipping parameter 414 of another activation layer 410. Alternatively, the initialization module 404 is configured to globally initialize activation layer 410 parameters, such that each activation layer 410 is assigned a common scaling parameter 412 and a common clipping parameter 414, prior to training. With respect to Equations 1-3, above, the scaling parameter 412 is representative of variables denoted s (e.g., s₁ and s₂) and the clipping parameter 414 is representative of variables denoted C (e.g., C₁ and C₂).

In this manner, the scaling parameter 412 defines a degree by which a numerical value, within a range of numerical values, is to be amplified relative to zero. For instance, the scaling parameter 412 defines at least one range of numerical values and a function (e.g., linear or nonlinear, depending on a type of the activation scaled clipping layer 120) for amplifying a numerical value that falls within the at least one range of numerical values. The clipping parameter 414 for an activation scaled clipping layer 120 defines a threshold numerical value and a clipping value, which causes the layer 120 to express numerical values resulting from processing according to the scaling parameter that satisfy the threshold numerical value as the clipping value in output 126.

After initializing the untrained machine learning model 406, the initialization module 404 communicates the untrained machine learning model 406 with its initialized parameters to a training module 416. The training module 416 is representative of functionality of the model training system 402 to obtain training data 418 for the untrained machine learning model 406 and cause the untrained machine learning model 406 to generate training outputs 420 by processing the training data 418 according to an objective. For instance, in an example implementation where the untrained machine learning model 406 is configured as an image classification model, the training data 418 includes unlabeled images and ground truth data for the unlabeled images (e.g., labels classifying each of the unlabeled images).

In this example implementation, the training module 416 inputs the unlabeled images from the training data 418 to the untrained machine learning model 406. Based on its image classification objective, the untrained machine learning model 406 predicts a label that classifies each of the unlabeled images included in the training data 418. The training module 416 aggregates these predicted labels as training outputs 420 and communicates the training outputs 420 together with ground truth data included in the training data 418 to the loss module 422. Although described with respect to an image classification objective, this example objective is not limiting and the training data 418 and training outputs 420 are instead representative of training data and predicted outputs for a variety of classification objectives.

The loss module 422 is representative of functionality of the model training system 402 to monitor an accuracy of the untrained machine learning model 406 in correctly classifying the training data 418 via the training outputs 420. To do so, the loss module 422 is configured to analyze the training outputs 420 and compare the training outputs 420 to ground truth information included in the training data 418. The loss module 422 is configured to compare the training outputs 420 to the ground truth information described in the training data 418 using any suitable metric, which in implementations depends on a specific task or objective for which the untrained machine learning model 406 is trained.

For instance, the loss module 422 is configured to quantify an accuracy of the training outputs 420 by considering absolute differences between individual ones of the training outputs 420 and corresponding ground truth information described by the training data 418. Alternatively or additionally, the loss module 422 is configured to calculate a mean squared error of the training outputs 420 relative to the ground truth information described in the training data 418. In this manner, the loss module 422 is configured to assess an effectiveness (e.g., accuracy) of the untrained machine learning model 406 during training using any suitable loss function, such as likelihood loss, cross entropy loss, L1 loss, L2 loss, squared loss, combinations thereof, and so forth.

Based on a comparison of the training outputs 420 to the ground truth information described by the training data 418, the loss module 422 generates a loss function 424, which is used by the model training system 402 to refine parameters of the untrained machine learning model 406 (e.g., the neuron weights 408, the scaling parameter 412, and the clipping parameter 414). For instance, in implementations generating the loss function 424 includes computing loss derivatives for the scaling parameter 412 and clipping parameter 414 during iterations of a gradient descent algorithm. As an example, with respect to the illustrated example of FIG. 2, during back-propagation gradient to the scaling parameter 412 is expressed as set forth in Equation 4 and gradient to the clipping parameter 414 is expressed as set forth in Equation 5:

$$\frac{\partial y}{\partial s} = \{ \begin{matrix}0 , & x ∈ ( - ∞ , 0 ) \\ x , & x ∈ [ 0 , \frac{C}{s} ) \\ 0 , & x ∈ [ \frac{C}{s} , + ∞ )\end{matrix} \qquad ( Eq . 4 )$$

$$\frac{\partial y}{\partial C} = \{ \begin{matrix}0 , & x ∈ ( - ∞ , 0 ) \\ 1 , & x ∈ [ \frac{C}{s} , + ∞ )\end{matrix} \qquad ( Eq . 5 )$$

In this manner, the loss function 424 can be expressed as L1+L2+L3, where L1 represents a loss function for the particular task or objective upon which the untrained machine learning model 406 is trained, L2 is an additional term representing the scaling parameter 412 from Equation 4, and L3 is an additional term representing the clipping parameter 414 from Equation 5. In some implementations, the terms representing the scaling parameter 412 and the clipping parameter 414 in the loss function 424 are specific to each instance of an activation layer 410 in the untrained machine learning model 406. In this manner, the loss function 424 is configured to include terms representing the scaling parameter 412 and the clipping parameter 414 for each of a plurality of activation scaled clipping layers 120 included in the untrained machine learning model 406.

The model training system 402 uses the loss function 424 to update parameters (e.g., at least one of neuron weights 408, scaling parameter 412, or clipping parameter 414) of the untrained machine learning model 406 for a training iteration. The model training system 402 continues to generate a loss function 424 in the manner described above for a plurality of training iterations until the training outputs 420 achieve a threshold difference relative to ground truth data represented in the training data 418. This threshold difference is determined using any suitable metric. In some implementations, the metric used to determine a threshold difference between the training outputs 420 and ground truth training data is specified by a user of a processing device implementing the model training system 402.

Upon achieving the threshold difference between the training outputs 420 and the ground truth information represented in the training data 418, the model training system 402 outputs the untrained machine learning model 406 with its parameters as trained by the loss function 424 as trained machine learning model 426. The trained machine learning model 426 is thus configured for use by a prediction module 428 to process input data 430 and generate an output 432 that classifies one or more features represented in the input data 430. In some implementations, the prediction module 428 is implemented by a same processing device as the processing device implementing the model training system 402. Alternatively, the prediction module 428 is implemented by a different processing device than the processing device implementing the model training system 402.

Because the trained machine learning model 426 includes at least one neuron associated with an activation scaled clipping layer 120, the output 432 that classifies one or more features of the input data 430 is generated based on processing by the activation scaled clipping layer 120. For instance, the output 432 is generated based on a numerical value output by the at least one neuron (e.g., a numerical value output by the sum function 118) using the scaling parameter 412 and the clipping parameter 414 assigned to the at least one neuron during training. Having considered example details of generating a trained machine learning model that includes at least one neuron associated with an activation scaled clipping layer that includes a learned scaling parameter and a learned clipping parameter, consider now example procedures to illustrate aspects of the techniques described herein.

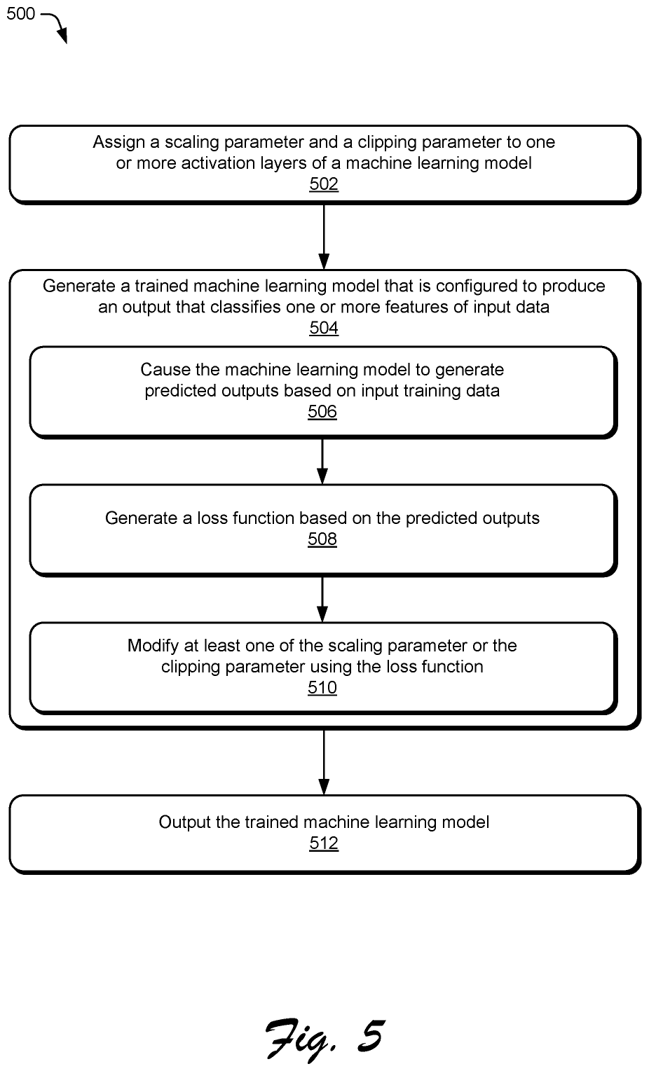

FIG. 5 depicts a procedure 500 in an example implementation of generating a trained machine learning model configured as a neural network having at least one node that is associated with an activation scaled clipping layer. A scaling parameter and a clipping parameter are assigned to one or more activation layers of a machine learning model (block 502). The initialization module 404, for instance, assigns a scaling parameter 412 and a clipping parameter 414 to an activation scaled clipping layer 120 associated with a node in a neural network, such as a node of the neural network architecture represented in example 100. In some implementations, the activation scaled clipping layer 120 to which the scaling parameter 412 and the clipping parameter 414 are assigned is configured as a linear activation scaled clipping layer 122. Alternatively or additionally, the activation scaled clipping layer 120 to which the scaling parameter 412 and the clipping parameter 414 are assigned is configured as a nonlinear activation scaled clipping layer 124.

In some implementations, the initialization module 404 globally assigns one or more of a scaling parameter 412 or a clipping parameter 414 to activation scaled clipping layers 120 included in the untrained machine learning model 406. For instance, the initialization module 404 assigns one or more of a common scaling parameter 412 or a common clipping parameter 414 to each activation scaled clipping layer 120 included in the layer 120. Alternatively, the initialization module 404 assigns one or more of a first scaling parameter or a first clipping parameter to each linear activation scaled clipping layer 122 and assigns one or more of a second scaling parameter or a second clipping parameter to each nonlinear activation scaled clipping later 124 included in the untrained machine learning model 406. Alternatively, the initialization module 404 assigns one or more of a scaling parameter 412 or a clipping parameter 414 to an activation scaled clipping layer 120 on an individual basis.

A trained machine learning model that is configured to produce an output that classifies one or more features of input data is generated (block 504). The model training system 402, for instance, generates the trained machine learning model 426 that is configured to produce an output 432 that classifies one or more features of input data 430. As part of generating the trained machine learning model 426, the machine learning model is caused to generate predicted outputs based on input training data (block 506). The training module 416, for instance, causes the untrained machine learning model 406 as initialized by the initialization module 404 to generate training outputs 420 from training data 418.

As further part of generating the trained machine learning model 426, a loss function is generated based on the predicted outputs (block 508). The loss module 422, for instance, generates loss function 424 by comparing the training outputs 420 to ground truth information described by the training data 418. The loss function 424 is configured to include at least one term for adjusting the scaling parameter 412 of an activation layer 410 and at least one term for adjusting the clipping parameter 414 of the activation layer 410.

As further part of generating the trained machine learning model 426, at least one of the scaling parameter or the clipping parameter is modified using the loss function (block 510). The model training system 402, for instance, applies the loss function 424 to the untrained machine learning model 406 during a training iteration and adjusts one or more of the scaling parameter 412 or the clipping parameter 414 of an activation layer 410 based on the corresponding terms set forth in the loss function 424. In some implementations, the loss function 424 includes individual terms for the scaling parameter 412 and the clipping parameter 414 for each of a plurality of activation layers, such that changes to the scaling parameter 412 and/or the clipping parameter 414 for one activation layer 410 differ from changes to the scaling parameter 412 and/or the clipping parameter 414 for another activation layer 410. The model training system 402 continues this process of generating a loss function 424 and modifying at least one of the scaling parameter 412 or the clipping parameter 414 for an activation layer 410 during each of a plurality of training iterations.

The trained machine learning model is then output (block 512). The model training system 402, for instance, outputs the trained machine learning model 426 in response to determining that the training outputs 420 achieve a threshold difference relative to ground truth information described in the training data 418 during one of the training iterations. As output, the trained machine learning model 426 is configured with the neuron weights 408 as well as the scaling parameter 412 and clipping parameter 414 learned for one or more activation layers 410 during training.

Although features and elements are described above in particular combinations, each feature or element is usable alone without the other features and elements or in various combinations with or without other features and elements. In this manner, many variations are possible based on the disclosure herein.

The various functional units illustrated in the figures and/or described herein (including, where appropriate, the activation scaled clipping layer 120, the model training system 402, the trained machine learning model 426, and the prediction module 428) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method comprising:
initializing a machine learning model by assigning a scaling parameter and a clipping parameter to one or more activation layers of the machine learning model;
generating a trained machine learning model configured to produce an output that classifies one or more features of input data by:
causing the machine learning model to generate predicted outputs based on input training data;
generating a loss function based on the predicted outputs; and
modifying at least one of the scaling parameter or the clipping parameter using the loss function; and
outputting the trained machine learning model.

2. The method of claim 1, wherein the machine learning model comprises a neural network including a plurality of neurons, each of the plurality of neurons configured to produce an output using a numerical representation of eight or fewer bits.

3. The method of claim 1, wherein the machine learning model comprises a neural network including a plurality of neurons, each of the plurality of neurons being associated with one of the one or more activation layers and configured to produce an output that is processed by the one of the one or more activation layers to activate another one of the plurality of neurons.

4. The method of claim 1, wherein the scaling parameter defines a degree by which a numerical value within a range of numerical values is to be amplified relative to zero.

5. The method of claim 4, wherein the scaling parameter causes linear amplification of the range of numerical values relative to zero.

6. The method of claim 4, wherein the scaling parameter causes nonlinear amplification of the range of numerical values relative to zero.

7. The method of claim 1, wherein the clipping parameter defines a threshold numerical value and causes numerical values output by the one or more activation layers that satisfy the threshold numerical value to be expressed as the threshold numerical value.

8. The method of claim 1, wherein training the machine learning model is performed over a plurality of training iterations and comprises performing the causing the machine learning model to generate the predicted outputs based on the input training data, the generating the loss function based on the predicted outputs, and the modifying the at least one of the scaling parameter or the clipping parameter using the loss function during each of the plurality of training iterations.

9. The method of claim 1, wherein outputting the machine learning model is performed responsive to determining that the predicted outputs generated during training satisfy a threshold difference from ground truth information for the training data.

10. The method of claim 1, wherein generating the loss function comprises comparing the predicted outputs to ground truth information for the training data.

11. The method of claim 1, further comprising producing the output that classifies the one or more features of the input data by providing the input data as input to the trained machine learning model.

12. A method comprising:
obtaining a machine learning model that includes a neural network comprising a plurality of neurons, at least one of the plurality of neurons being associated with an activation layer that processes a numerical value output by the one of the plurality of neurons using a scaling parameter and a clipping parameter; and
causing the neural network to produce an output that classifies one or more features of input data by inputting the input data to the machine learning model, the output that classifies the one or more features of input data being generated based on a result of the activation layer processing the numerical value output by the one of the plurality of neurons using the scaling parameter and the clipping parameter.

13. The method of claim 12, wherein the scaling parameter defines a degree by which the numerical value is to be amplified relative to zero responsive to determining that the numerical value is within a range of numerical values.

14. The method of claim 13, wherein the scaling parameter causes linear amplification of the numerical value responsive to determining that the numerical value is within the range of numerical values.

15. The method of claim 13, wherein the scaling parameter causes nonlinear amplification of the numerical value responsive to determining that the numerical value is within the range of numerical values.

16. The method of claim 12, wherein the clipping parameter defines a threshold numerical value and causes the numerical value output by the one of the plurality of neurons to be expressed as the threshold numerical value responsive to determining that the numerical value output by the one of the plurality of neurons satisfies the threshold numerical value.

17. The method of claim 12, wherein the numerical value output by the one of the plurality of neurons is expressed using eight or fewer bits.

18. A system comprising:
an initialization module to initialize a machine learning model by assigning a scaling parameter and a clipping parameter to one or more activation layers of the machine learning model;
a training module to generate a trained machine learning model by:
causing the machine learning model to generate predicted outputs based on input training data;
generating a loss function based on the predicted outputs; and
modifying at least one of the scaling parameter or the clipping parameter using the loss function; and
a prediction model to generate an output by processing input data using the trained machine learning model.

19. The system of claim 18, wherein the machine learning model comprises a neural network including a plurality of neurons, each of the plurality of neurons configured to produce an output using a numerical representation of eight or fewer bits.

20. The system of claim 18, wherein the scaling parameter defines a degree by which a numerical value within a range of numerical values is to be amplified relative to zero and the clipping parameter defines a threshold numerical value and causes numerical values that satisfy the threshold numerical value to be expressed as the threshold numerical value.
